(19) United States
(12) Patent Application Publication
(10) Pub. No.: US 2019/0263090 A1
(43) Pub. Date: Aug. 29, 2019

(54) Building Products and Associated Methods for Providing Contoured and Elevated Features for Artificial Surfaces

(71) Applicant: Chosen Products, LLC, : Rocky Face, GA (US)

(72) Inventor: Bernard Ty Allen, Rocky Face, GA (US)

(21) Appl. No.: 16/286,143

(22) Filed: Feb. 26, 2019

Related U.S. Application Data
(60) Provisional application No. 62/635,149, filed on Feb. 26, 2018.

(51) Int. Cl. B32B 5/32; A47C 1/14; E21D 9/14; E02B 3/14; E01D 18/00; E02B 3/10; E02D 17/20; A47C 5/12; B32B 7/12; B32B 37/12

(52) U.S. Cl. CPC B32B 5/32; E01D 2101/40; E21D 9/14; E02B 3/14; A47C 1/146; E01D 18/00; E02B 3/106; E02D 17/205; A47C 5/12; B32B 7/12; B32B 37/12; E02D 2300/0046; E02D 2300/0025; E02D 2300/0006; A47C 1/143

(57) ABSTRACT

A modular foundation structure for artificial surface systems includes a structural base layer with a shaped rigid foam having contoured and elevated features, an adhesive layer covering the structural base layer, and an impact and thermal protective layer attached to the structural base layer via the adhesive layer. The impact and thermal protective layer is configured to support an artificial surface layer and has a relatively higher melting point and compression recovery factor than the structural base layer. The shaped rigid may be a closed-cell foam such as Expanded Polystyrene (EPS) or Expanded polyethylene (EPE), and the impact and thermal protective layer may be a bead molded Expanded Polypropylene (EPP) foam. The impact and thermal protective layer may have a melting point of about 300 degrees Fahrenheit, and the structural base layer has a melting point of less than 200 degrees Fahrenheit.

### RELATED APPLICATIONS

This application claims the benefit under 35 U.S.C. § 119(e) of U.S. Patent Application Ser. No. 62/635,149 titled BUILDING PRODUCTS AND ASSOCIATED METHODS FOR PROVIDING CONTOURED AND ELEVATED FEATURES FOR ARTIFICIAL SURFACES, docket no. 3232.00003 filed Feb. 26, 2018, the entire contents of which are incorporated herein, except to the extent that disclosure therein conflicts with disclosure herein.

### FIELD OF THE INVENTION

The present invention relates in general to the field of artificial turf and activity systems. Such artificial turf systems may be used for playgrounds, sports playing fields, synthetic lawns, golf courses, and other similar types of fields or surfaces.

### BACKGROUND OF THE INVENTION

In general, artificial turf systems, such as sports playing fields, are often made of a mix of natural and/or synthetic/artificial material. A foundation layer (e.g., dirt, gravel, sand or other suitable material) is sometimes provided. A padding layer may then be installed, and the artificial grass is positioned on top.

Design considerations for sports playing fields include athlete's safety, surface hardness, water drainage, heat management, ease of assembly/installation, durability, longevity, uniformity, resistance to change in weather according to seasons, stability, etc. Playgrounds, synthetic lawns, golf courses, and other similar types of fields or surfaces may also involve such considerations.

For example, U.S. Pat. No. 5,467,977 to Beck and entitled “Portable Pitching Mound” is directed to a portable pitching mound that includes an expanded plastic core covered with a flexible, sheet-like artificial turf material.

Also, U.S. Pat. No. 5,941,041 to Robinson et al, and entitled “Play Structure Building Panel” is directed to a modular play structure building panel which can be connected to other identical panels to construct various play structures, such as tunnels, cylindrical towers, and walls.

However, it may be desirable to provide safer, simpler and more cost effective contoured and elevated features for artificial surfaces such as turf fields, playgrounds, commercial and residential property yards, and that are impact resistant, insulative, safer, stable, durable and flexible.

### SUMMARY OF THE INVENTION

With the foregoing in mind, embodiments of the invention are related to modular, protective, contoured and elevated features for artificial surfaces such as turf fields.

An embodiment is directed to a modular foundation structure for artificial surface systems including a structural base layer comprising a shaped rigid foam having contoured and elevated features, an adhesive layer covering the structural base layer, and an impact and thermal protective layer attached to the structural base layer via the adhesive layer, and configured to support an artificial surface layer. The impact and thermal protective layer has a relatively higher melting point and compression recovery factor than the structural base layer.

Additionally, and/or alternatively, the shaped rigid foam comprises a closed-cell foam. The closed cell foam may be Expanded Polystyrene (EPS) or Expanded polyethylene (EPE).

Also, the adhesive may be a closed cell foam adhesive.

Additionally, and/or alternatively, the impact and thermal protective layer may be a bead molded Expanded Polypropylene (EPP) foam.

The impact and thermal protective layer may have a melting point of about 300 degrees Fahrenheit, and the structural base layer has a melting point of less than 200 degrees Fahrenheit.

Additionally, and/or alternatively, the shaped rigid foam with contoured and elevated features defines a mound, tunnel mound, reclined chair, bench, bridge and/or a berm.

The impact and thermal protective layer may be configured to support an artificial surface layer including artificial turf or poured-in-place rubber.

Another embodiment is directed to an artificial surface system including an artificial surface layer; and a modular foundation structure supporting the artificial surface layer. The modular foundation structure includes a structural base layer comprising a shaped rigid foam having contoured and elevated features, an adhesive layer covering the structural base layer, and an impact and thermal protective layer attached to the structural base layer via the adhesive layer, and configured to support the artificial surface layer. The impact and thermal protective layer has a relatively higher melting point and compression recovery factor than the structural base layer.

Additionally, and/or alternatively, the shaped rigid foam comprises a closed-cell foam. The closed cell foam may be Expanded Polystyrene (EPS) or Expanded polyethylene (EPE).

Also, the adhesive may be a closed cell foam adhesive.

Additionally, and/or alternatively, the impact and thermal protective layer may be a bead molded Expanded Polypropylene (EPP) foam.

The impact and thermal protective layer may have a melting point of about 300 degrees Fahrenheit, and the structural base layer has a melting point of less than 200 degrees Fahrenheit.

Additionally, and/or alternatively, the shaped rigid foam with contoured and elevated features defines a mound, tunnel mound, reclined chair, bench, bridge and/or a berm.

The impact and thermal protective layer may be configured to support an artificial surface layer including artificial turf or poured-in-place rubber.

Another embodiment is directed to a method of making a modular foundation structure for artificial surface systems. The method includes forming a structural base layer by shaping rigid foam to have contoured and elevated features, covering the structural base layer with an adhesive layer, and attaching an impact and thermal protective layer to the structural base layer via the adhesive layer. The impact and thermal protective layer is configured to support an artificial surface layer having a relatively higher melting point and compression recovery factor than the structural base layer.

Additionally, and/or alternatively, the shaped rigid foam comprises a closed-cell foam. The closed cell foam may be Expanded Polystyrene (EPS) or Expanded polyethylene (EPE).

Also, the adhesive may be a closed cell foam adhesive.

Additionally, and/or alternatively, the impact and thermal protective layer may be a bead molded Expanded Polypropylene (EPP) foam.

The impact and thermal protective layer may have a melting point of about 300 degrees Fahrenheit, and the structural base layer has a melting point of less than 200 degrees Fahrenheit.

Additionally, and/or alternatively, the shaped rigid foam with contoured and elevated features defines a mound, tunnel mound, reclined chair, bench, bridge and/or a berm.

The impact and thermal protective layer may be configured to support an artificial surface layer including artificial turf or poured-in-place rubber.

Thus, in an example embodiment, the contoured and elevated features are designed from and comprise the use of multiple layers including a first rigid structural foam layer, an adhesive layer, and a thermal and impact protective layer. An artificial turf layer, such as synthetic grass, may then cover the foundation structure. The structural foam layer may be EPS (Expanded Polystyrene) or Expanded polyethylene (EPE) while the protective layer may be bead molded EPP (Expanded Polypropylene) foam.

Some advantages of the contoured and elevated features and method of the present embodiments include that such features can be modular components that are off-the-shelf or custom, and that absorb repeated impacts which also serves to attenuate impacts and provide a fall safety component. The embodiments of the contoured and elevated features are also insulative with a relatively high melting point, as well as resistant to various chemicals and oils.

### BRIEF DESCRIPTION OF THE DRAWINGS

The example embodiments are best understood from the following detailed description when read with the accompanying drawing figures. In fact, the dimensions may be arbitrarily increased or decreased for clarity of discussion. Wherever applicable and practical, like reference numerals refer to like elements.

FIGS. 1A-1D are schematic views illustrating an example embodiment of a tunnel mound including a modular foundation structure in accordance with features of the present invention.

FIG. 1A is a schematic top view illustrating the example embodiment of the modular foundation structure for the tunnel mound.

FIG. 1B is a schematic perspective view illustrating the tunnel mound of FIG. 1A.

FIG. 1C is a schematic first side view illustrating the tunnel mound of FIG. 1A.

FIG. 1D is a schematic second side view with enlarged portion illustrating the tunnel mound of FIG. 1A.

FIGS. 2A-2D are schematic views illustrating an example embodiment of a mound including a modular foundation structure in accordance with features of the present invention.

FIG. 2A is a schematic top view illustrating the example embodiment of the modular foundation structure for the mound.

FIG. 2B is a schematic perspective view illustrating the mound of FIG. 2A.

FIG. 2C is a schematic side view with enlarged portion illustrating the mound of FIG. 2A.

FIG. 2D is a schematic front view illustrating the mound of FIG. 2A.

FIGS. 3A-3D are schematic views illustrating an example embodiment of a recliner including a modular foundation structure in accordance with features of the present invention.

FIG. 3A is a schematic top view illustrating the example embodiment of the modular foundation structure for the recliner.

FIG. 3B is a schematic perspective view illustrating the recliner of FIG. 3A.

FIG. 3C is a schematic side view with enlarged portion illustrating the recliner of FIG. 3A.

FIG. 3D is a schematic front side view illustrating the recliner of FIG. 3A.

FIGS. 4A-4E are schematic views illustrating an example embodiment of a bench including a modular foundation structure in accordance with features of the present invention.

FIG. 4A is a schematic side view with enlarged portion illustrating the example embodiment of the bench.

FIG. 4B is a schematic perspective view illustrating the bench of FIG. 4A.

FIG. 4C is another schematic perspective view illustrating the bench of FIG. 4A with turf.

FIG. 4D is a schematic top view illustrating the bench of FIG. 4A.

FIG. 4E is a schematic top view illustrating an example embodiment of a double wide bench of FIG. 4A.

FIGS. 5A-5D are schematic views illustrating an example embodiment of a bridge including a modular foundation structure in accordance with features of the present invention.

FIG. 5A is a schematic top view illustrating the example embodiment of the bridge.

FIG. 5B is a schematic perspective view illustrating the bridge of FIG. 5A.

FIG. 5C is a schematic side view with enlarged portion illustrating the bridge of FIG. 5A.

FIG. 5D is a schematic front side view illustrating the bridge of FIG. 5A.

FIGS. 6A-6D are schematic views illustrating an example embodiment of a berm in accordance with features of the present invention.

FIG. 6A is a schematic top view illustrating the example embodiment of the berm.

FIG. 6B is a schematic perspective view illustrating the berm of FIG. 6A.

FIG. 6C is a schematic side view with enlarged portion illustrating the berm of FIG. 6A.

FIG. 6D is a schematic front side view illustrating the berm of FIG. 6A.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

As discussed above, artificial surfaces (e.g. turf surfaces) and systems are known. Such artificial surface systems may include the use of synthetic grass-like fibers bound with a backing material and filled with a material such as rubber pieces. Such artificial surface systems may include poured-in-place rubber surfaces, such as for playgrounds. The artificial surfaces are for use on various support layers such as concrete or compacted dirt or gravel with an underlayment therebetween, as would be appreciated by those skilled in the art.

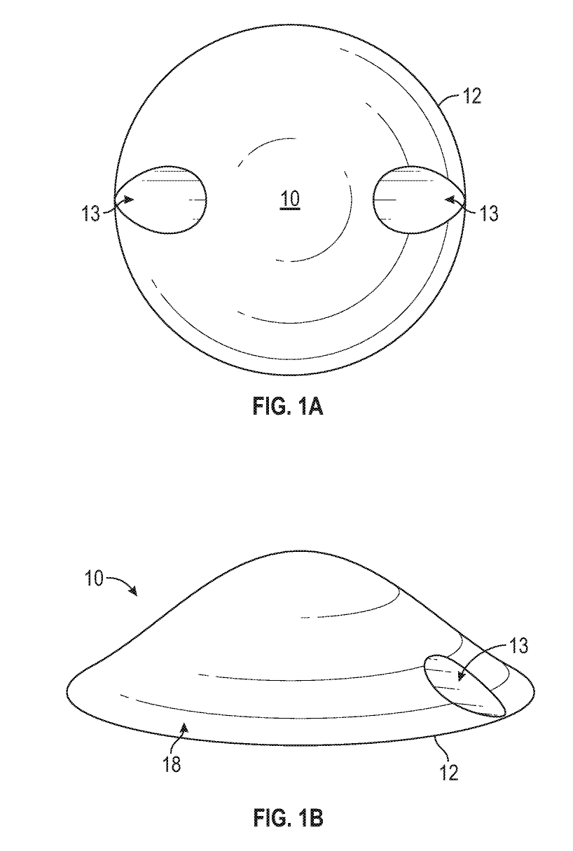

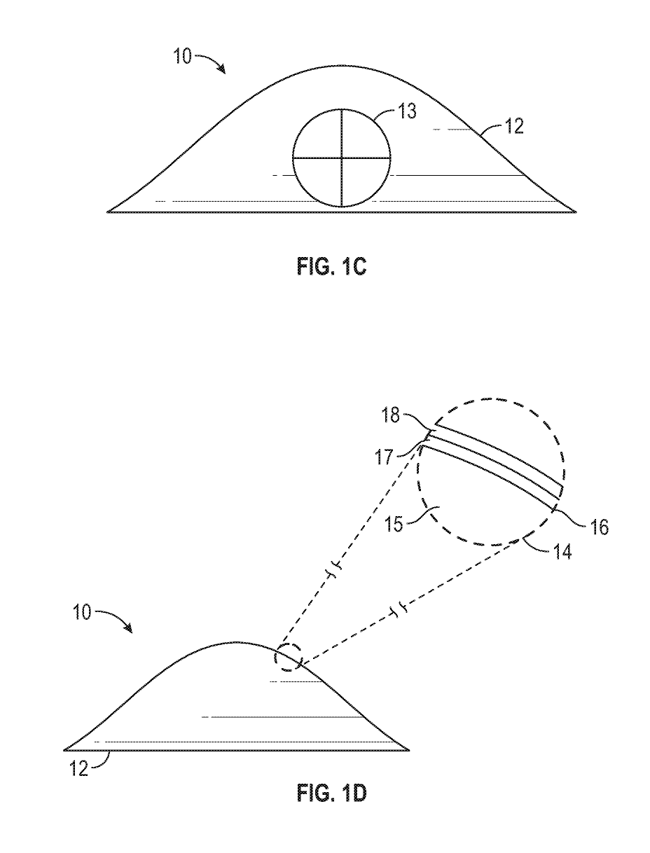

FIGS. 1-6 illustrate various modular contoured and elevated features or components for artificial surface systems. The figures include top, side and perspective views illustrating example embodiments of a tunnel mound 10, mound 20, recliner 30, bench 40, bridge 50 and berm 60 in accordance with features of the present invention. These modular foundation structure components may be off-the-shelf or custom sized for desired applications integrated with artificial surfaces including playgrounds, athletic fields, residential and/or commercial synthetic surfaces, for example.

FIGS. 1A-1D are schematic views illustrating an example embodiment of a tunnel mound 10 including a modular foundation structure 12 in accordance with features of the present invention. FIG. 1A is a schematic top view illustrating the modular foundation structure 12 for the tunnel mound 10. The tunnel mound 10 includes a tunnel 13, for example, bored through the foundation structure 12 and lined with a hard plastic. FIG. 1B is a schematic perspective view illustrating the tunnel mound 10 covered with synthetic turf 18, FIG. 1C is a schematic first side view illustrating the tunnel mound 10, and FIG. 1D is a schematic second side view with enlarged portion 14 illustrating the layers of the modular foundation structure 12 of the tunnel mound 10, which will be described in further detail below.

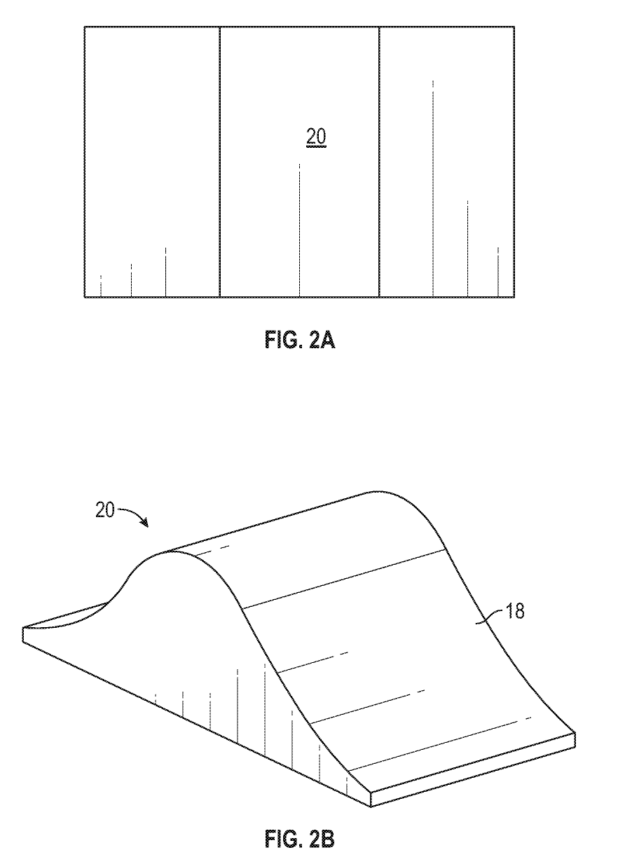

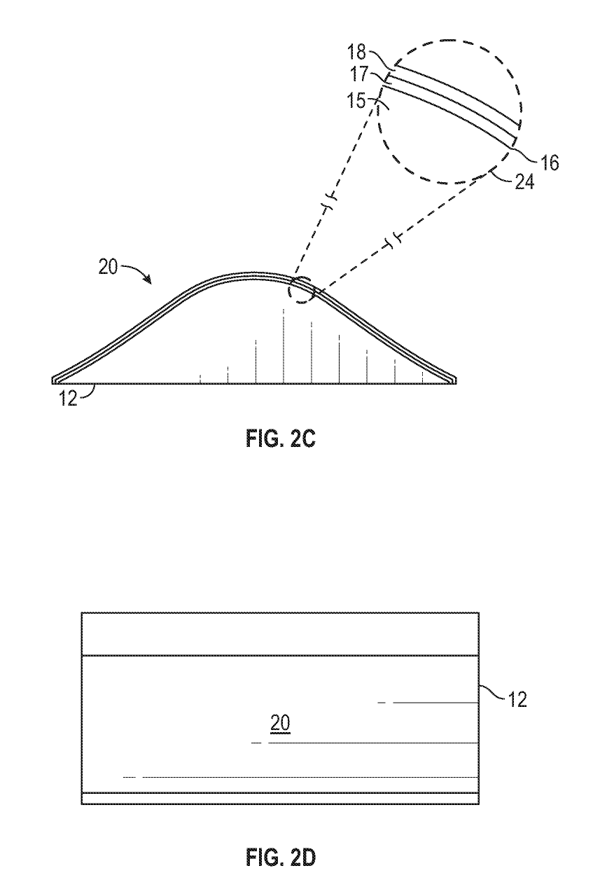

FIGS. 2A-2D are schematic views illustrating an example embodiment of a mound 20 including a modular foundation structure 12 in accordance with features of the present invention. FIG. 2A is a schematic top view illustrating the modular foundation structure 12 for the mound 20. FIG. 2B is a schematic perspective view illustrating the mound 20 covered with synthetic turf 18, FIG. 2C is a schematic side view with enlarged portion 24 illustrating the layers of the modular foundation structure 12 of the mound 20, and FIG. 2D is a schematic front view illustrating the mound 20.

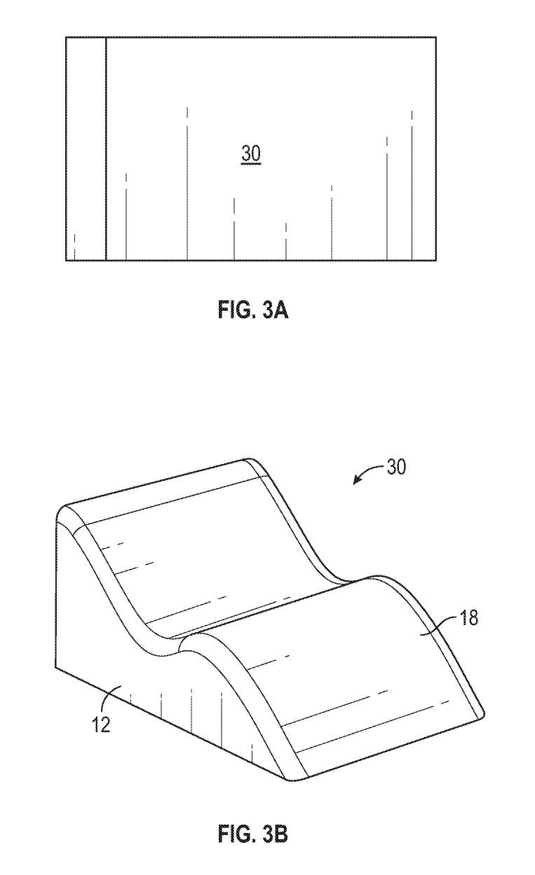

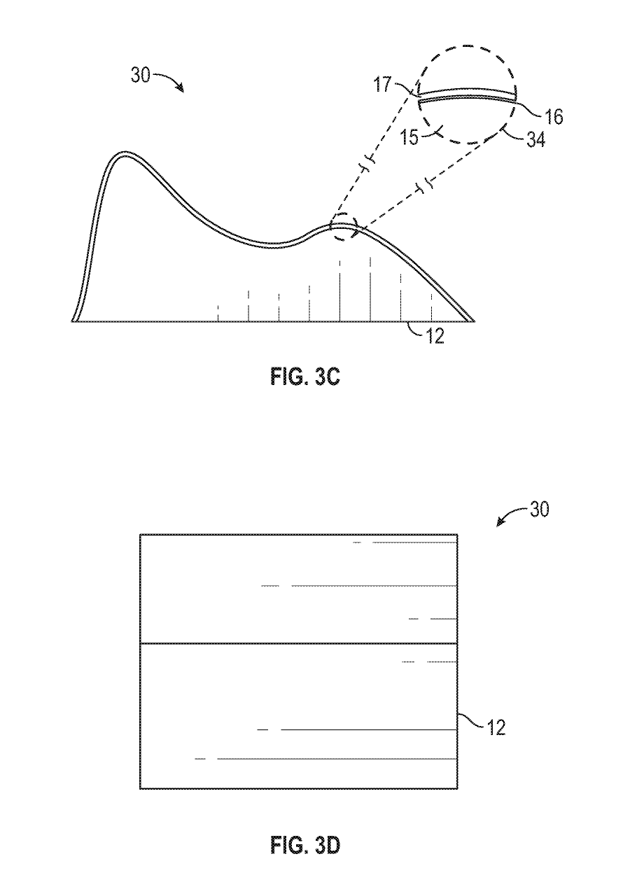

FIGS. 3A-3D are schematic views illustrating an example embodiment of a recliner 30 including a modular foundation structure 12 in accordance with features of the present invention. FIG. 3A is a schematic top view illustrating the modular foundation structure 12 for the recliner 30. FIG. 3B is a schematic perspective view illustrating the recliner 30 covered with synthetic turf 18, FIG. 3C is a schematic side view with enlarged portion 34 illustrating the layers of the modular foundation structure 12 of the recliner 30, and FIG. 3D is a schematic front side view illustrating the recliner 30.

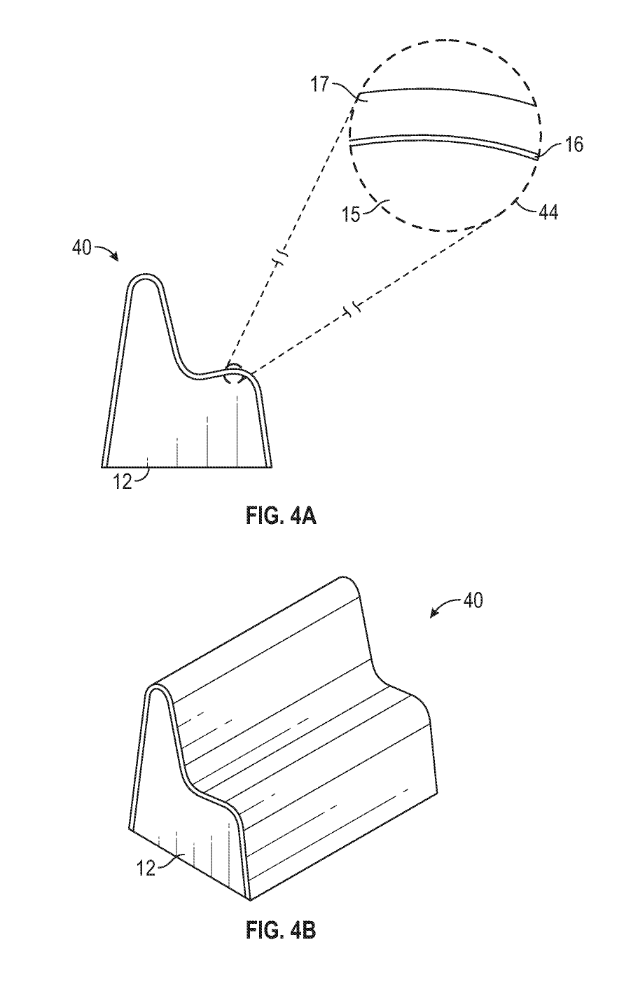

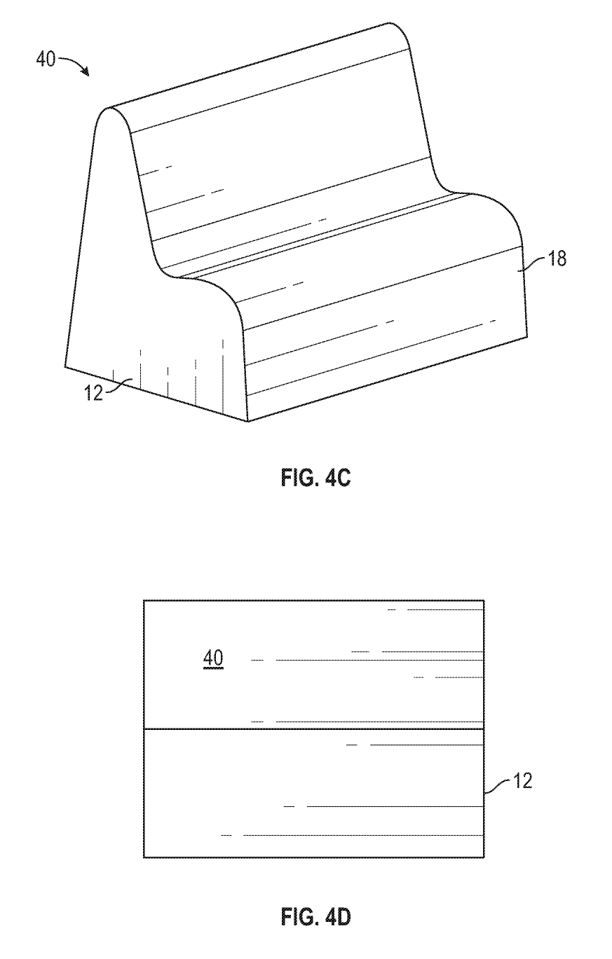

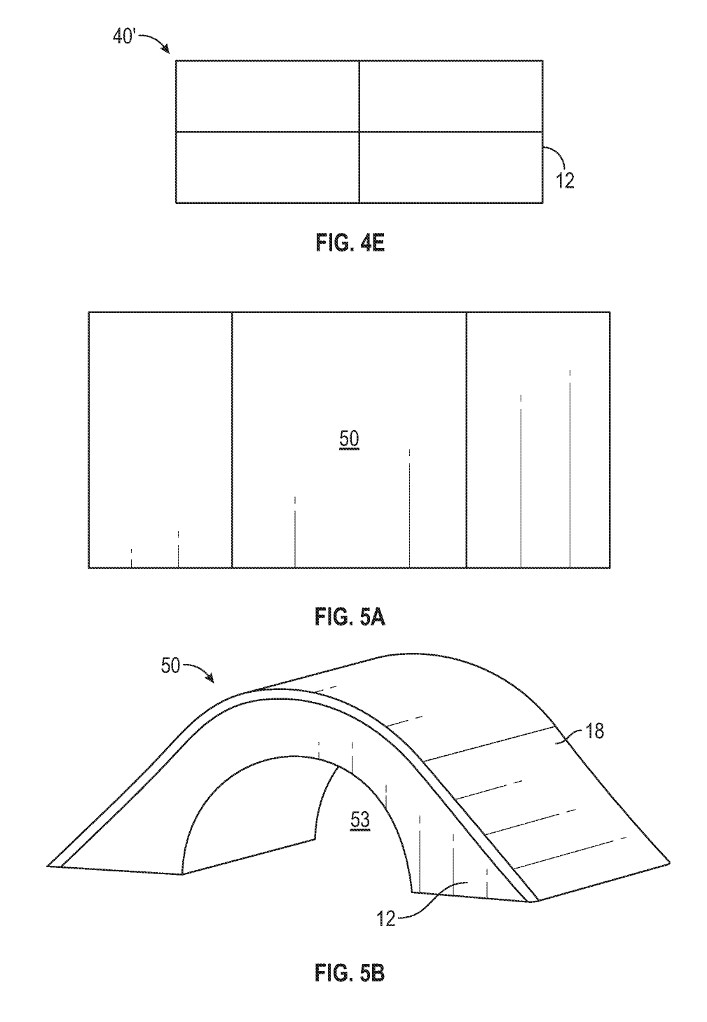

FIGS. 4A-4E are schematic views illustrating an example embodiment of a bench 40 including a modular foundation structure 12 in accordance with features of the present invention. FIG. 4A is a schematic side view with enlarged portion 44 illustrating the layers of the modular foundation structure 12 of the bench 40. FIG. 4B is a schematic perspective view illustrating the bench 40, FIG. 4C is another schematic perspective view illustrating the bench 40 covered with synthetic turf 18, FIG. 4D is a schematic top view illustrating the bench 40, and FIG. 4E is a schematic top view illustrating an example embodiment of a double wide bench 40′.

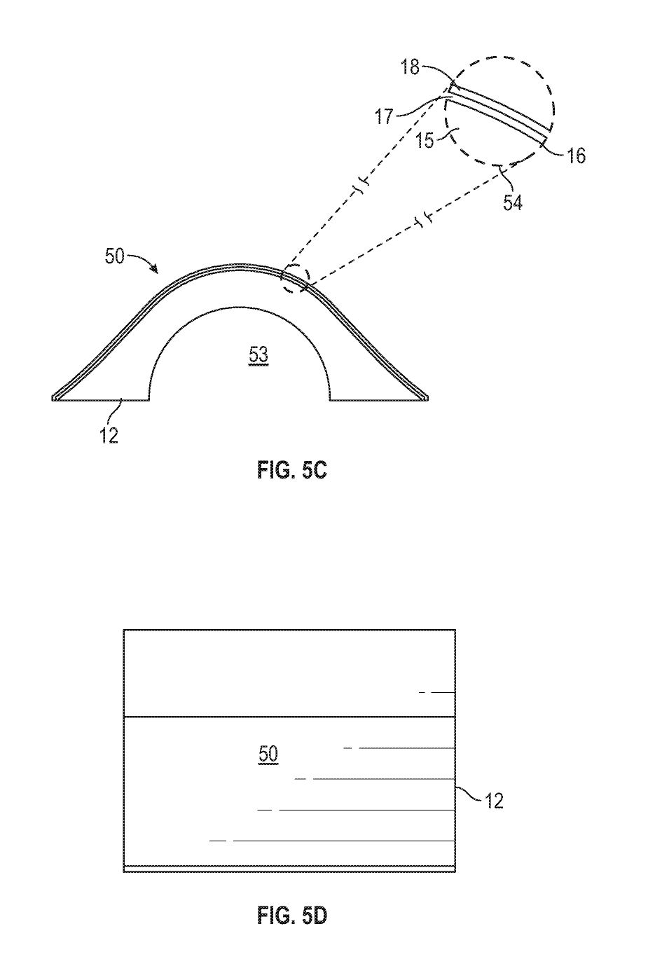

FIGS. 5A-5D are schematic views illustrating an example embodiment of a bridge 50 including a modular foundation structure 12 in accordance with features of the present invention. FIG. 5A is a schematic top view illustrating the bridge 50. FIG. 5B is a schematic perspective view illustrating the bridge 50 covered with synthetic turf 18, and including an underpass 53 or space. FIG. 5C is a schematic side view with enlarged portion 54 illustrating the layers of the modular foundation structure 12 of the bridge 50, and FIG. 5D is a schematic front side view illustrating the bridge 50.

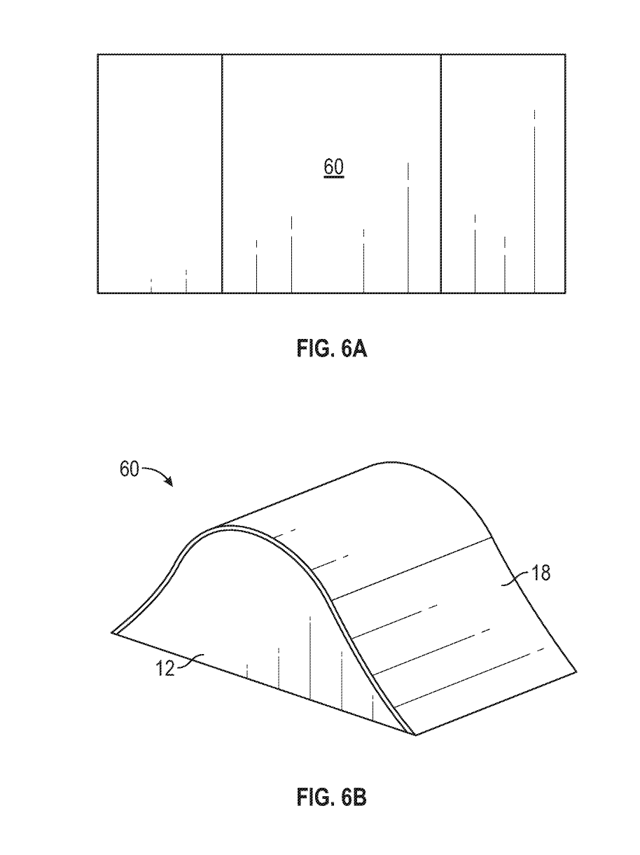

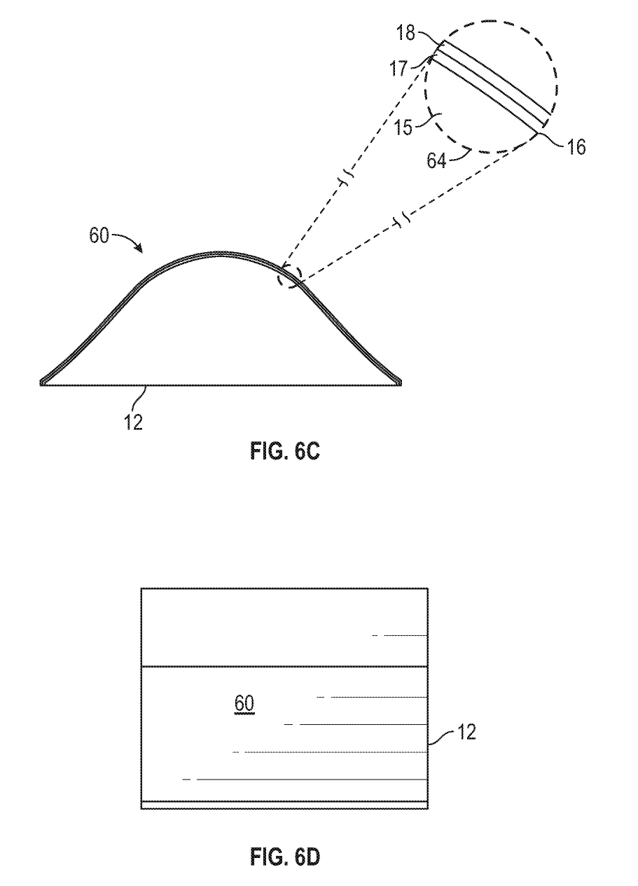

FIGS. 6A-6D are schematic views illustrating an example embodiment of a berm 60 including a modular foundation structure 12 in accordance with features of the present invention. FIG. 6A is a schematic top view illustrating the berm 60. FIG. 6B is a schematic perspective view illustrating the berm 60 covered with synthetic turf 18, FIG. 6C is a schematic side view with enlarged portion 64 illustrating the layers of the modular foundation structure 12 of the berm 60, and FIG. 6D is a schematic front side view illustrating the berm 60.

The modular foundation structure 12 includes a structural base layer 15 comprising a shaped rigid foam having contoured and elevated features. An adhesive layer 16 covers the structural base layer 15. An impact and thermal protective layer 17 is attached to the structural base layer 15 via the adhesive layer 16. The impact and thermal protective layer 17 is configured to support an artificial surface layer 18, such as synthetic turf grass or rubber. The impact and thermal protective layer 17 has a relatively higher melting point and compression recovery factor than the structural base layer, as will be discussed below.

The impact and thermal protective layer may have a melting point of about 300 degrees Fahrenheit, and the structural base layer has a melting point of less than 200 degrees Fahrenheit. The impact and thermal protective layer may be configured to support an artificial surface layer including artificial turf or poured-in-place rubber.

The shaped rigid foam defining the structural base layer 15 is preferably a closed-cell foam such as Expanded Polystyrene (EPS) or Expanded polyethylene (EPE). The adhesive may be a closed cell foam adhesive. And, the impact and thermal protective layer 17 may be a bead molded Expanded Polypropylene (EPP) foam. Of course, other materials with substantially similar properties may be applicable. The shaped rigid foam with contoured and elevated features defines the mound 10, tunnel mound 20, reclined chair 30, bench 40, bridge 50 and/or the berm 60, as discussed above. Of course, other shapes are contemplated as would be appreciated by those skilled in the art.

Custom shaped landscapes with various contoured and elevated features may be provided by a landscape architect. Such custom shapes would be formed in the rigid foam to define the structural base layer 15, prior to layering with the adhesive layer 16 and the impact and thermal protective layer 17 attached thereto. The custom shape is configured to support the artificial surface layer 18, such as synthetic turf grass or rubber.

As such, the shapes (e.g., custom, tunnel mound, mound, recliner, bench, bridge and berm) are created using the rigid foam. Once the shapes are created, a layer of EPP foam is then applied to the top using a closed cell expanded foam adhesive. This EPP layer varies in thickness depending on use but a preferred example thickness is ½ inch.

Because of the low compressive properties and low melting point of EPS, it has been determined that if synthetic turf is put directly over the top, the heat generated under the turf can reach as high as 200 degrees F. The melting point of EPS is roughly 175 degrees, so melting of the EPS is a serious concern. Also, a concern is that once the EPS foam shape is compressed (e.g. from an impact) it does not recover to its original form.

Thus, in view of the low melting point of the EPS foam shape, and the compressibility issue, the present embodiments include a coating over the EPS in order to protect the shape from impact and the heat, so that the EPS foam shape can still be used under turf or other artificial surfaces, such as poured-in-place rubber.

Through many experiments it was determined that putting a layer of EPP foam over the top provides some desired advantages. A benefit of this layering approach includes protection of the EPS foam from impacts. Since EPP has high compressive strength properties it is able to absorb repeated impacts, which are expected in a playground environment. This also serves as impact attenuation and may provide a fall safety component suitable for playgrounds.

EPP foam is an excellent insulator with a high melting point of about 300 degrees F. Because of this feature, the EPP foam protective layer will keep the heat away from the EPS foam shape and prevent such from melting.

EPP foam is highly resistant to most oils and chemicals where EPS is not. By coating the EPS with the EPP it will allow products with binder, such as poured-in-place rubber, to be used over the top without adverse effects.

Polystyrene foam such as Expanded Polystyrene (EPS) is a rigid and tough, closed-cell foam. It is usually white and made of pre-expanded polystyrene beads. EPS is used for many applications e.g. trays, plates, bowls and fish boxes. Other uses include molded sheets for building insulation and packing material (“peanuts”) for cushioning fragile items inside boxes. Sheets are commonly packaged as rigid panels (size 4 by 8 or 2 by 8 feet).

Expanded polyethylene (EPE) foam is a molded semi-rigid, non-crosslinked and closed-cell type of polyethylene foam that has a many applications due characteristics including: Non-abrasive; Flexible; Strong; Lightweight; Non-dusting; highly-resilient; Moisture/weather resistant; Tear/puncture-resistant; Meets Mil-Spec requirements; Odorless; Chemically inert; High load bearing capacity; Cost/labor efficient; Non-corrosive; Buoyant; Thermal insulation; multiple strike energy management; Dimensional stability; Uniform cell structure; Impact & shock absorption; Vibration dampening; Excellent compressive creep properties; Shatter Proof; Bacteria/chemical/grease/mold/oil/solvent-resistant; Less concavity when die-cut (compared to PE & XLPE); CFC-free; Ozone friendly; and Recyclable.

Any other foam materials, such as biodegradable or eco-friendly foams, that have the needed stiffness, durability and other features desired for contoured and elevated artificial surface features, may also be used as the base shape as would be appreciated by those skilled in the art.

Expanded Polypropylene (EPP) is a highly versatile closed-cell bead foam that provides a unique range of properties, including outstanding energy absorption, multiple impact resistance, thermal insulation, buoyancy, water and chemical resistance, exceptionally high strength to weight ratio and 100% recyclability. EPP can be made in a wide range of densities, from 15 to 200 grams per liter, which are transformed by molding into densities ranging from 18 to 260 grams per liter. Individual beads are fused into final product form by the steam chest molding process resulting in a strong and lightweight shape.

As such, the components are made from an environmentally-sound, “green” material that is 100% recyclable, and requires no VOCs (Volatile Organic Compounds), chlorofluorocarbon or other compounds that are recognized as most damaging to the environment.

Downward forces exerted by humans that are walking, running, falling, jumping etc., on the contoured and elevated components are absorbed by the combination of layers. Of course, the thickness of the layers can be chosen based upon the desired balance between stability and load/impact absorption, as would be appreciated by those skilled in the art.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The above description provides specific details, such as material types and processing conditions to provide a thorough description of example embodiments. However, a person of ordinary skill in the art would understand that the embodiments may be practiced without using these specific details.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made, and equivalents may be substituted for elements thereof without departing from the scope of the invention.

In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item. Thus, the scope of the invention should be determined by the appended claims and their legal equivalents, and not by the examples given.

1. A modular foundation structure for artificial surface systems comprising:
a structural base layer comprising a shaped rigid foam having contoured and elevated features;
an adhesive layer covering the structural base layer; and
an impact and thermal protective layer attached to said structural base layer via said adhesive layer, and configured to support an artificial surface layer;
said impact and thermal protective layer having a relatively higher melting point and compression recovery factor than said structural base layer.

2. The modular foundation structure according to claim 1, wherein said shaped rigid foam comprises a closed-cell foam.

3. The modular foundation structure according to claim 2, wherein said closed cell foam comprises at least one of Expanded Polystyrene (EPS) or Expanded polyethylene (EPE).

4. The modular foundation structure according to claim 1, wherein said adhesive layer comprises a closed cell foam adhesive.

5. The modular foundation structure according to claim 1, wherein said impact and thermal protective layer comprises bead molded Expanded Polypropylene (EPP) foam.

6. The modular foundation structure according to claim 1, wherein said impact and thermal protective layer has a melting point of about 300 degrees Fahrenheit, and said structural base layer has a melting point of less than 200 degrees Fahrenheit.

7. The modular foundation structure according to claim 1, wherein said shaped rigid foam defines at least one of a mound, tunnel mound, reclined chair, bench, bridge and berm.

8. The modular foundation structure according to claim 1, wherein said impact and thermal protective layer is configured to support an artificial surface layer including artificial turf.

9. The modular foundation structure according to claim 1, wherein said impact and thermal protective layer is configured to support an artificial surface layer including poured-in-place rubber.

10. An artificial surface system comprising:
an artificial surface layer; and
a modular foundation structure supporting said artificial surface layer;
said modular foundation structure comprising:
a structural base layer comprising a shaped rigid foam having contoured and elevated features;
an adhesive layer covering the structural base layer; and
an impact and thermal protective layer attached to said structural base layer via said adhesive layer, and configured to support the artificial surface layer;
said impact and thermal protective layer having a relatively higher melting point and compression recovery factor than said structural base layer.

11. The artificial surface system according to claim 10, wherein said shaped rigid foam comprises a closed-cell foam.

12. The artificial surface system according to claim 11, wherein said closed cell foam comprises at least one of Expanded Polystyrene (EPS) or Expanded polyethylene (EPE).

13. The artificial surface system according to claim 10, wherein said adhesive layer comprises a closed cell foam adhesive.

14. The artificial surface system according to claim 10, wherein said impact and thermal protective layer comprises bead molded Expanded Polypropylene (EPP) foam.

15. The artificial surface system according to claim 10, wherein said impact and thermal protective layer has a melting point of about 300 degrees Fahrenheit, and said structural base layer has a melting point of less than 200 degrees Fahrenheit.

16. The artificial surface system according to claim 10, wherein said shaped rigid foam defines at least one of a mound, tunnel mound, reclined chair, bench, bridge and berm.

17. The artificial surface system according to claim 10, wherein said artificial surface layer includes artificial turf.

18. The artificial surface system according to claim 10, wherein said impact and thermal protective layer is configured to support an artificial surface layer includes poured-in-place rubber.

19. A method of making a modular foundation structure for artificial surface systems, the method comprising:
forming a structural base layer by shaping rigid foam to have contoured and elevated features;
covering the structural base layer with an adhesive layer; and
attaching an impact and thermal protective layer to the structural base layer via the adhesive layer;
the impact and thermal protective layer configured to support an artificial surface layer having a relatively higher melting point and compression recovery factor than the structural base layer.

20. The method according to claim 19, wherein the shaped rigid foam comprises a closed-cell foam and wherein the closed cell foam comprises at least one of Expanded Polystyrene (EPS) or Expanded polyethylene (EPE).

21. The method according to claim 19, wherein the adhesive layer comprises a closed cell foam adhesive.

22. The method according to claim 19, wherein the impact and thermal protective layer comprises bead molded Expanded Polypropylene (EPP) foam.

23. The method according to claim 19, wherein the impact and thermal protective layer has a melting point of about 300 degrees Fahrenheit, and the structural base layer has a melting point of less than 200 degrees Fahrenheit.

24. The method according to claim 19, wherein the shaped rigid foam having contoured and elevated features defines at least one of a mound, tunnel mound, reclined chair, bench, bridge and berm; and wherein the impact and thermal protective layer is configured to support an artificial surface layer including one of artificial turf and poured-in-place rubber.
